(19) United States
(12) Patent Application Publication
(10) Pub. No.: US 2025/0086498 A1
(43) Pub. Date: Mar. 13, 2025

(54) SYSTEMS AND METHODS FOR GENERATING SYNTHETIC TRAINING DATA

(71) Applicant: Capital One Services, LLC, McLean, VA (US)

(72) Inventors: Samuel SHARPE, Cambridge, MA (US); Galen RAFFERTY, Mahomet, IL (US); Taylor TURNER, Richmond, VA (US); Owen REINERT, Queens, NY (US)

(73) Assignee: Capital One Services, LLC, McLean, VA (US)

(21) Appl. No.: 18/464,179

(22) Filed: Sep. 8, 2023

(51) Int. Cl. G06N 20/00

(52) U.S. Cl. CPC G06N 20/00

(57) ABSTRACT

Methods and systems for generating synthetic data. In some aspects, the system receives a first set of candidate behaviors, each of which comprises plain text. The system processes the first set of candidate behaviors using a first language processing model to generate a set of representations in an embedding space. For each representation in the set of representations, the system processes the representation using a second language processing model to generate a first sequence of behavioral tokens representative of a timeline of user activities. Using the set of representations and first sequence of behavior tokens, the system updates the second language processing model. Using the updated second language processing model, the system processes a second set of candidate behaviors to generate a second sequence of behavior tokens.

### SUMMARY

Machine learning models often require abundant and high-quality training data. However, training data for models dealing in abstractions such as embedding spaces can be scarce, and ensuring data quality is especially difficult. Many models for behavior prediction or language processing suffer from a lack of controllable and accurate training data, resulting in models that perform sub-optimally. Behavior prediction models may be targeted at predicting likely user activities following a specific history of user activities, which may be used as input by the model. For example, a behavior prediction model may aim to predict a user's upcoming resource consumption by processing an input including a log of instances of resource consumption, including the extent and category of the resource consumption. Language processing models, in some embodiments, may take as input one or more text tokens, which are real values symbolizing words, phrases or sentences, and generate text tokens as output in relation to the input text tokens. For example, a language processing model may be a conversation system which generates answers in response to questions posed to it in plain text.

Methods and systems are described herein for novel uses and/or improvements to artificial intelligence applications and in particular to generating or supplementing training data for a behavior prediction model using an embedding model. For example, the system may be used for adapting behavior descriptions in plain text into a format usable by a deep learning model trained to predict sequences of tokens based on input tokens. The system may use a first model to process plain text descriptions and generate a set of representations in a real-valued space. The system may train or update a second model using the set of representations. The second model may be designed to take representations as input and predict sequences of next behaviors. The resulting sequences of behavior tokens may be used to further update the second model, for example in an unsupervised learning framework. Doing so provides advantages of creating a reliable and controllable method of creating synthetic data to tune the second model by relying on the first model to accurately capture desired situations in the representation space.

Existing systems have not contemplated using an embedding model to create targeted, high-quality training data for a behavior prediction model to optimize performance. Existing systems additionally have not contemplated using a language processing model to generate behavior tokens to perform behavior prediction. Instead, existing systems frequently use algorithms which are not finely tuned as is the case with language processing models used herein. Therefore, existing systems are deficient compared to the systems and methods described herein in aspects like predictive error rates, range of outcomes captured, and explainability. Additionally, adapting existing systems to use language processing models for behavior prediction faces significant challenges like the lack of a clear framework for generating training data or evaluative benchmarks for language processing models. The systems and methods described herein provide solutions to both problems, using embedding models to generate training data in a real-valued space native to the behavior prediction language processing model, and in using reinforcement or unsupervised learning to retrain or update the behavior prediction language processing model in accordance with new situations.

In some aspects, a method for generating synthetic data is disclosed herein, the method comprising: receiving a first set of candidate behaviors, wherein each candidate behavior comprises plain text; processing the first set of candidate behaviors using a first language processing model to generate a set of representations in an embedding space; for each representation in the set of representations, processing the representation using a second language processing model to generate a first sequence of behavioral tokens representative of a timeline of user activities; using the set of representations and first sequence of behavior tokens, updating the second language processing model; and using the updated second language processing model, processing a second set of candidate behaviors to generate a second sequence of behavior tokens.

For example, the systems and methods described herein may be used to translate user behaviors described using plain text into embedding vectors. The embedding vectors may be used by a user activity model to predict timelines for probable next behaviors. Such predictions for next behaviors may be used to, for example, fine-tune the user activity model or provide baseline guidance for other user categorization/clustering models.

Various other aspects, features, and advantages of the systems and methods described herein will be apparent through the detailed description and the drawings attached hereto. It is also to be understood that both the foregoing general description and the following detailed description are examples and are not restrictive of the scope of the systems and methods described herein. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data) unless the context clearly dictates otherwise.

### BRIEF DESCRIPTION OF THE DRAWINGS

FIG. 1 shows an illustrative diagram for a system which generates synthetic data using a first language processing model for a second model, in accordance with one or more embodiments.

FIG. 2 shows an illustration of behavior tokens being translated into representations, in accordance with one or more embodiments.

FIG. 3 shows illustrative components for a system for generating synthetic data using a first language processing model for a second model, in accordance with one or more embodiments.

FIG. 4 shows a flowchart of the steps involved in generating synthetic data using a first language processing model for a second model, in accordance with one or more embodiments.

### DETAILED DESCRIPTION

In the following description, for the purposes of explanation, numerous specific details are set forth in order to provide a thorough understanding of the embodiments described herein. It will be appreciated, however, by those having skill in the art that the embodiments may be practiced without these specific details or with an equivalent arrangement. In other cases, well-known structures and devices are shown in block diagram form in order to avoid unnecessarily obscuring the embodiments.

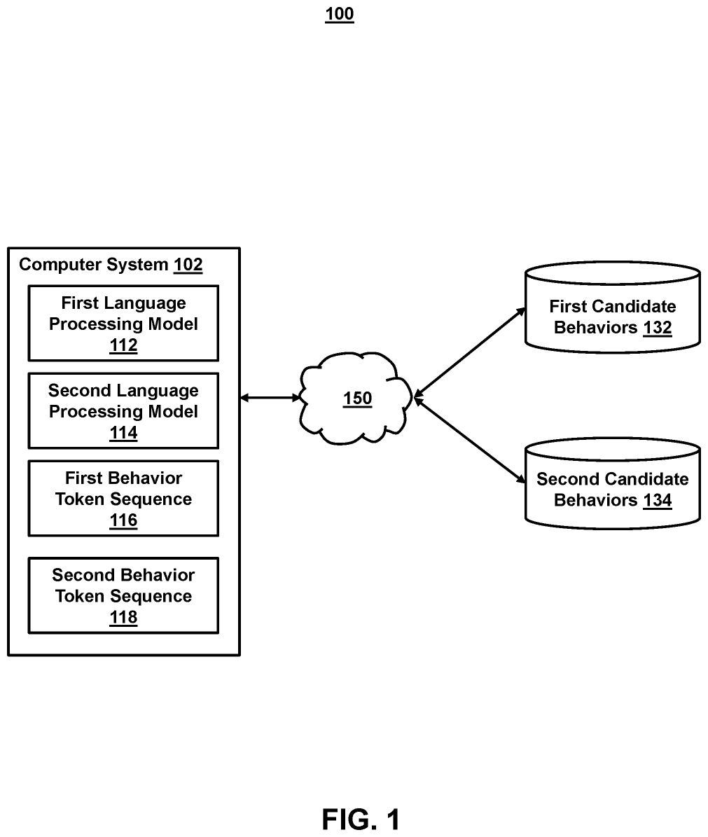

FIG. 1 shows an illustrative diagram for system 100, which contains hardware and software components connected via network 150 and used for generating synthetic data using a first language processing model for a second model, in accordance with one or more embodiments. For example, Computer System 102, a part of system 100, may include First Language Processing Model 112, Second Language Processing Model 114, First Behavior Token Sequence(s) 116 and Second Behavior Token Sequence(s) 118. Additionally, system 100 may create, store, and use First Candidate Behaviors 132 and Second Candidate Behaviors 134 in one or more contexts.

The system (e.g., system 100) may receive First Candidate Behaviors 132. First Candidate Behaviors 132 may be plain text descriptions of various hypothetical scenarios. In some embodiments, the hypothetical scenarios may pertain to actions by one or more users and/or responses to actions by users. For example, a candidate behavior in First Candidate Behaviors 132 may be that a user used too much bandwidth on a network, causing a crash. First Candidate Behaviors 132 may contain a plurality of candidate behaviors in a dataset format. Each entry in the dataset may be text describing a candidate behavior, the text comprising sequence(s)s of words, sentences, paragraphs, or passages in any combination. In some embodiments, the system may discretize candidate behaviors in First Candidate Behaviors 132 to consist of text tokens. Each text token may, for example, be a word or a punctuation mark. Alternatively, text tokens may correspond to sentences. Text tokens may contain text in plain alphanumerical form and may not be embedded to real values. In some embodiments, First Candidate Behaviors 132 may be associated with a set of labels. The labels may indicate an outcome expected from the candidate behaviors described, or a real outcome observed from a real event described using a candidate behavior. The relationship between a candidate behavior and an outcome may be predetermined before First Candidate Behaviors 132 is processed by language models. For example, a candidate behavior may describe a user overloading a network. The candidate behavior may be associated with an expected outcome, which may be determined to be network failure.

The system may process the First Candidate Behaviors 132 using a first language processing model (e.g., First Language Processing Model 112) to generate a set of representations. First Language Processing Model 112 may be, for example, a deep learning model trained to map candidate behaviors to user activity representations in the real-valued embedding space. First Language Processing Model 112 may use algorithms such as word2vec, doc2vec, bidirectional encoder representations, or TF-IDF. First Language Processing Model 112 may take as input text tokens corresponding to a candidate behavior in First Candidate Behaviors 132, for example. First Language Processing Model 112 may output a set of representations in a first real-valued space. Representations may be referred to as embeddings herein. Each representation in the set of representations may be a sequential data structure in the first real-valued space. For example, a representation may include a set of tokens, each of which contains one or more real numbers, and a set of sequential relations indicating a linear order among the set of tokens. For example, a representation may be similar to a linked list, the contents of which are real numbers symbolizing text tokens.

First Language Processing Model 112 may be trained on training data containing candidate behaviors in the same format as First Candidate Behaviors 132. For example, the system may use unsupervised learning to train a deep neural network which translates candidate behaviors into representations in the first real-valued space. For example, First Language Processing Model 112 may be trained on candidate behaviors whose correct embeddings in the first real-valued space are known. Using a supervised or reinforcement learning framework, the system in this example may train First Language Processing Model 112 on a loss metric symbolizing the alignment between the output of First Language Processing Model 112 and the true representation corresponding to a candidate behavior.

In some embodiments, First Candidate Behaviors 132 may be labeled with outcomes. First Language Processing Model 112 may process the labeled candidate behaviors to generate a set of representations labeled with outcomes. The labeled set of representations may be used to train Second Language Processing Model 114.

For each representation in the set of representations, the system may process the representation using a second language processing model (e.g., Second Language Processing Model 114). For each representation of a candidate behavior, Second Language Processing Model 114 may output a sequence(s) of behavior tokens representative of a timeline of user activities (e.g., First Behavior Token Sequence(s) 116). Second Language Processing Model 114 may be trained to perform sequential next-token prediction using a transformer algorithm. Second Language Processing Model 114 may generate First Behavior Token Sequence(s) 116 based on an input representation by processing the sequential data structure of the input representation to determine a first set of candidate tokens. The first candidate tokens represent a set of expected continuations to the input representation, for example, a next action in a sequence(s) of actions. Each candidate token may be associated with a probability, indicating the relative likelihood that the candidate token is the correct continuation of the sequence(s) so far. After generating the first candidate token, Second Language Processing Model 114 may process the input representation in conjunction with a selected first candidate token as a prototype of First Behavior Token Sequence(s) 116 to generate a second set of candidate tokens, each of which are also associated with a probability. The system may select a token from the second set of candidate tokens, and iteratively use Second Language Processing Model 114 to process the current length of First Behavior Token Sequence(s) 116 to generate next tokens. By doing so, Second Language Processing Model 114 is able to consider the full context leading up to any particular token. Second Language Processing Model 114 may be trained on, for example, input representation sequence(s) s in an unsupervised learning framework. In some embodiments, First Candidate Behaviors 132 may be labeled with a set of outcomes. Using representations of First Candidate Behaviors 132 generated by First Language Processing Model 112 in combination with the set of outcomes, the system may train or update Second Language Processing Model 114.

In some embodiments, the system may train Second Language Processing Model 114 by training a first candidate model and a second candidate model. For example, the first candidate model may use an algorithm like a deep neural network. For example, the second candidate model may use a different algorithm like a bidirectional encoder representation algorithm. In some embodiments, the system may use part of the training data for the first candidate model and the remainder of the training data to train the second candidate model. The system may calculate, for example, fit metrics for the first and second candidate models. A fit metric may be a combination of a bias score according to a bias metric and an error score based on cross-validation for a candidate model. Alternatively, the system may calculate performance metrics for the first and second candidate models. A performance metric may indicate, for example, the adherence of a candidate model to a performance standard at runtime. In some embodiments, the system may process a candidate model to extract an attention matrix. The attention matrix may be indicative of extents of consideration the candidate model gives to each of its input features. The system may compare the attention matrix against a preset benchmark attention matrix to generate an attention score. The attention score may, for example, be used as a performance metric. Alternatively or additionally, the attention score may be used to update the candidate model. Using fit metrics and/or performance metrics corresponding to the first and second candidate models, the system may generate Second Language Processing Model 114 by combining parameters from both candidate models as a weighted average using the metrics.

In some embodiments, the system may process Second Language Processing Model 114 to generate a correspondence map, where the correspondence map correlates representations in the embedding space to plain text. The correspondence map may be indicative of the translations between representations and plain text used by Second Language Processing Model 114. The system may use the correspondence map to generate an alignment score for First Language Processing Model 112. For example, the system may compare a representation generated for a particular plain text sequence(s) by First Language Processing Model 112 and a representation generated by the correspondence map. A numerical distance between the two representations in the first real-valued space may be the alignment score. The system may update First Language Processing Model 112 using the alignment score, updating its parameters to achieve an intended threshold of alignment.

The system may update Second Language Processing Model 114 using the set of representations and First Behavior Token Sequence(s) 116. For example, the system may use a reinforcement learning framework if First Behavior Token Sequence(s) 116 is associated with a set of outcomes. The system may, for example, use a loss function capturing the differences between the output of Second Language Processing Model 114 and the correct outcomes corresponding to a token sequence(s) in First Behavior Token Sequence(s) 116. Parameters for Second Language Processing Model 114 may be updated to minimize the loss function. In some embodiments, the system may use an unsupervised learning approach to update Second Language Processing Model 114 with First Behavior Token Sequence(s) 116.

Using the updated second language processing model, the system may process a second set of candidate behaviors (e.g., Second Candidate Behaviors 134) to generate a second sequence(s) of behavior tokens (e.g., Second Behavior Token Sequence(s) 118). Second Candidate Behaviors 134 may be in the same format as First Candidate Behaviors 132, and also include text tokens. The system may input Second Candidate Behaviors 134 to First Language Processing Model 112 and generate a second set of representations in the first real-valued space. The system may then input the second set of representations to Second Language Processing Model 114. Second Language Processing Model 114 may generate Second Behavior Token Sequence(s) 118 by iteratively processing the sequential data structures of the input representations to determine sequence(s)s of candidate tokens. Each candidate behavior in Second Candidate Behaviors 134 may correspond to a sequence(s) of candidate tokens, for example.

Second Behavior Token Sequence(s) 118 may be used to train or update other machine learning models. For example, Second Candidate Behaviors 134 and Second Behavior Token Sequence(s) 118 may, in conjunction, be used as training data for a user classification model. Second Behavior Token Sequence(s) 118 may be determined to correspond to a set of severity scores. Users may be associated or correlated with certain behaviors in Second Candidate Behaviors 134, which are in turn associated with severity scores corresponding to Second Behavior Token Sequence(s) 118. In some embodiments, the system may process the first or second sequence(s) of behavioral tokens to determine clusters of user systems using a prototype-based clustering model. Each sequence of behavioral tokens is a prototype used by the prototype-based clustering model. In some embodiments, each cluster of user systems is associated with a scenario description in first set of scenario descriptions.

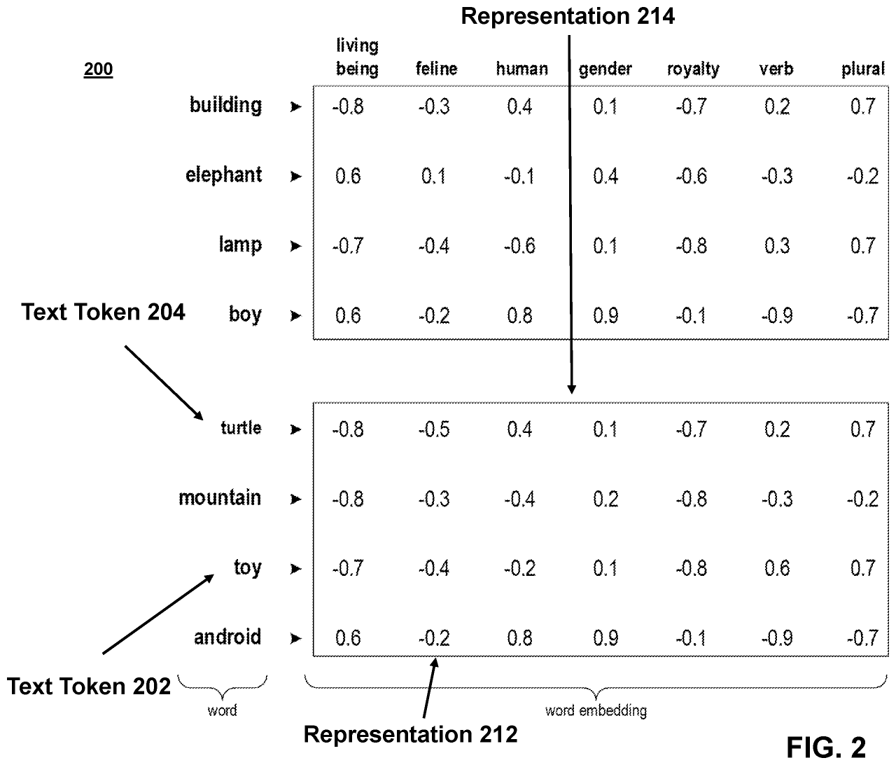

FIG. 2 shows illustration 200 for text tokens being projected to representations in a real-valued space. For example, Text Token 202 comprises the word “toy” and Text Token 204 comprises the word “turtle”. In some embodiments, some text tokens may include sentences or paragraphs instead of words. Alternatively, numbers, symbols, or punctuation may also be text tokens. Each text token may correspond to a representation. For example, Text Token 202 corresponds to Representation 212, a vector of real values: [−0.7, −0.4, −0.6, 0.1, −0.8, 0.3, 0.7]. The vector of real values is associated with a set of features, each of which correlates with an attribute which may be associated with a word. Text Token 204 may be associated with Representation 214, which is a vector of different real numbers associated with the same set of features: [−0.8, −0.3, 0.4, 0.1, −0.7, 0.2, 0.7]. For example, some features may correlate with whether a word signifies a human, what gender the word would be, or whether the word is a verb. In some embodiments, sentences, paragraphs, and symbols may be associated with a set of features different from the set used for words.

Representations in the format of Representation 212 and Representation 214 may be processed by a model such as Second Language Processing Model 114. Second Language Processing Model 114 may, for example, take an input representation of a vector of real values and use a combination of weights, biases and activations in a deep neural network to generate an output vector which is a transformation of the input representation. The output vector may be in the same format as the input representation, for example corresponding to the same set of features. The output vector may be a first behavior token in a behavior token sequence, e.g., Second Behavior Token Sequence 118. Second Language Processing Model 114 may then process the output vector to generate a second behavior token. The second behavior token may similarly be in the same format as the first behavior token and the input representation. The above process may iteratively repeat until Second Language Processing Model 114 outputs a vector indicating a stop. In some embodiments, Second Language Processing Model 114 may output multiple behavior token in each iteration, each of which may be associated with a probability. Second Language Processing Model 114 may, for example, use a random simulation method to select one output behavior token among the behavior tokens generated from a single input.

In some embodiments, representations such in the format of Representation 212 and Representation 214 may be used to cluster users. For example, each user in a set of users may be associated with a sequence of activities. The sequence of activities for a user may be projected to a set of representations by, e.g., First Language Processing Model 112. Thus, each user may correspond to a set of representations. The system may, for example, cluster the set of users to identify outliers or generate prototype representations for a prototype network model. Alternatively, the set of representations for a user may be used to assign a resource availability score to the user using a quantitative prediction model.

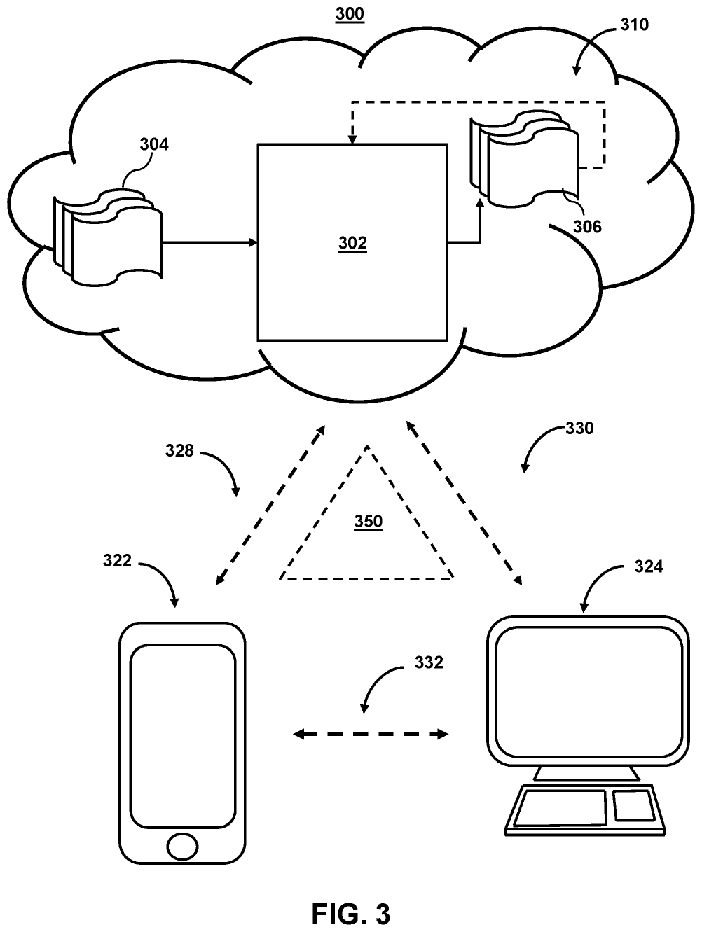

FIG. 3 shows illustrative components for a system used to communicate between the system and user devices and collect data, in accordance with one or more embodiments. As shown in FIG. 3, system 300 may include mobile device 322 and user terminal 324. While shown as a smartphone and personal computer, respectively, in FIG. 3, it should be noted that mobile device 322 and user terminal 324 may be any computing device, including, but not limited to, a laptop computer, a tablet computer, a hand-held computer, and other computer equipment (e.g., a server), including “smart,” wireless, wearable, and/or mobile devices. FIG. 3 also includes cloud components 310. Cloud components 310 may alternatively be any computing device as described above, and may include any type of mobile terminal, fixed terminal, or other device. For example, cloud components 310 may be implemented as a cloud computing system and may feature one or more component devices. It should also be noted that system 300 is not limited to three devices. Users may, for instance, utilize one or more devices to interact with one another, one or more servers, or other components of system 300. It should be noted, that, while one or more operations are described herein as being performed by particular components of system 300, these operations may, in some embodiments, be performed by other components of system 300. As an example, while one or more operations are described herein as being performed by components of mobile device 322, these operations may, in some embodiments, be performed by components of cloud components 310. In some embodiments, the various computers and systems described herein may include one or more computing devices that are programmed to perform the described functions. Additionally, or alternatively, multiple users may interact with system 300 and/or one or more components of system 300. For example, in one embodiment, a first user and a second user may interact with system 300 using two different components.

With respect to the components of mobile device 322, user terminal 324, and cloud components 310, each of these devices may receive content and data via input/output (hereinafter “I/O”) paths. Each of these devices may also include processors and/or control circuitry to send and receive commands, requests, and other suitable data using the I/O paths. The control circuitry may comprise any suitable processing, storage, and/or input/output circuitry. Each of these devices may also include a user input interface and/or user output interface (e.g., a display) for use in receiving and displaying data. For example, as shown in FIG. 3, both mobile device 322 and user terminal 324 include a display upon which to display data (e.g., conversational response, queries, and/or notifications).

Additionally, as mobile device 322 and user terminal 324 are shown as touchscreen smartphones, these displays also act as user input interfaces. It should be noted that in some embodiments, the devices may have neither user input interfaces nor displays and may instead receive and display content using another device (e.g., a dedicated display device such as a computer screen, and/or a dedicated input device such as a remote control, mouse, voice input, etc.). Additionally, the devices in system 300 may run an application (or another suitable program). The application may cause the processors and/or control circuitry to perform operations related to generating dynamic conversational replies, queries, and/or notifications.

Each of these devices may also include electronic storages. The electronic storages may include non-transitory storage media that electronically stores information. The electronic storage media of the electronic storages may include one or both of (i) system storage that is provided integrally (e.g., substantially non-removable) with servers or client devices, or (ii) removable storage that is removably connectable to the servers or client devices via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). The electronic storages may store software algorithms, information determined by the processors, information obtained from servers, information obtained from client devices, or other information that enables the functionality as described herein.

FIG. 3 also includes communication paths 328, 330, and 332. Communication paths 328, 330, and 332 may include the Internet, a mobile phone network, a mobile voice or data network (e.g., a 5G or LTE network), a cable network, a public switched telephone network, or other types of communications networks or combinations of communications networks. Communication paths 328, 330, and 332 may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. The computing devices may include additional communication paths linking a plurality of hardware, software, and/or firmware components operating together. For example, the computing devices may be implemented by a cloud of computing platforms operating together as the computing devices.

Cloud components 310 may include model 302, which may be a machine learning model, artificial intelligence model, etc. (which may be referred collectively as “models” herein). Model 302 may take inputs 304 and provide outputs 306. The inputs may include multiple datasets, such as a training dataset and a test dataset. Each of the plurality of datasets (e.g., inputs 304) may include data subsets related to user data, predicted forecasts and/or errors, and/or actual forecasts and/or errors. In some embodiments, outputs 306 may be fed back to model 302 as input to train model 302 (e.g., alone or in conjunction with user indications of the accuracy of outputs 306, labels associated with the inputs, or with other reference feedback information). For example, the system may receive a first labeled feature input, wherein the first labeled feature input is labeled with a known prediction for the first labeled feature input. The system may then train the first machine learning model to classify the first labeled feature input with the known prediction (e.g., predicting resource allocation values for user systems).

In a variety of embodiments, model 302 may update its configurations (e.g., weights, biases, or other parameters) based on the assessment of its prediction (e.g., outputs 306) and reference feedback information (e.g., user indication of accuracy, reference labels, or other information). In a variety of embodiments, where model 302 is a neural network, connection weights may be adjusted to reconcile differences between the neural network's prediction and reference feedback. In a further use case, one or more neurons (or nodes) of the neural network may require that their respective errors are sent backward through the neural network to facilitate the update process (e.g., backpropagation of error). Updates to the connection weights may, for example, be reflective of the magnitude of error propagated backward after a forward pass has been completed. In this way, for example, the model 302 may be trained to generate better predictions.

In some embodiments, model 302 may include an artificial neural network. In such embodiments, model 302 may include an input layer and one or more hidden layers. Each neural unit of model 302 may be connected with many other neural units of model 302. Such connections can be enforcing or inhibitory in their effect on the activation state of connected neural units. In some embodiments, each individual neural unit may have a summation function that combines the values of all of its inputs. In some embodiments, each connection (or the neural unit itself) may have a threshold function such that the signal must surpass it before it propagates to other neural units. Model 302 may be self-learning and trained, rather than explicitly programmed, and can perform significantly better in certain areas of problem solving, as compared to traditional computer programs. During training, an output layer of model 302 may correspond to a classification of model 302, and an input known to correspond to that classification may be input into an input layer of model 302 during training. During testing, an input without a known classification may be input into the input layer, and a determined classification may be output.

In some embodiments, model 302 may include multiple layers (e.g., where a signal path traverses from front layers to back layers). In some embodiments, back propagation techniques may be utilized by model 302 where forward stimulation is used to reset weights on the “front” neural units. In some embodiments, stimulation and inhibition for model 302 may be more free-flowing, with connections interacting in a more chaotic and complex fashion. During testing, an output layer of model 302 may indicate whether or not a given input corresponds to a classification of model 302 (e.g., predicting resource allocation values for user systems).

In some embodiments, the model (e.g., model 302) may automatically perform actions based on outputs 306. In some embodiments, the model (e.g., model 302) may not perform any actions. The output of the model (e.g., model 302) may be used to predict resource allocation values for user systems).

System 300 also includes API layer 350. API layer 350 may allow the system to generate summaries across different devices. In some embodiments, API layer 350 may be implemented on mobile device 322 or user terminal 324. Alternatively or additionally, API layer 350 may reside on one or more of cloud components 310. API layer 350 (which may be A REST or Web services API layer) may provide a decoupled interface to data and/or functionality of one or more applications. API layer 350 may provide a common, language-agnostic way of interacting with an application. Web services APIs offer a well-defined contract, called WSDL, that describes the services in terms of its operations and the data types used to exchange information. REST APIs do not typically have this contract; instead, they are documented with client libraries for most common languages, including Ruby, Java, PHP, and JavaScript. SOAP Web services have traditionally been adopted in the enterprise for publishing internal services, as well as for exchanging information with partners in B2B transactions.

API layer 350 may use various architectural arrangements. For example, system 300 may be partially based on API layer 350, such that there is strong adoption of SOAP and RESTful Web-services, using resources like Service Repository and Developer Portal, but with low governance, standardization, and separation of concerns. Alternatively, system 300 may be fully based on API layer 350, such that separation of concerns between layers like API layer 350, services, and applications are in place.

In some embodiments, the system architecture may use a microservice approach. Such systems may use two types of layers: Front-End Layer and Back-End Layer where microservices reside. In this kind of architecture, the role of the API layer 350 may provide integration between Front-End and Back-End. In such cases, API layer 350 may use RESTful APIs (exposition to front-end or even communication between microservices). API layer 350 may use AMQP (e.g., Kafka, RabbitMQ, etc.). API layer 350 may use incipient usage of new communications protocols such as gRPC. Thrift, etc.

In some embodiments, the system architecture may use an open API approach. In such cases, API layer 350 may use commercial or open-source API Platforms and their modules. API layer 350 may use a developer portal. API layer 350 may use strong security constraints applying WAF and DDOS protection, and API layer 350 may use RESTful APIs as standard for external integration.

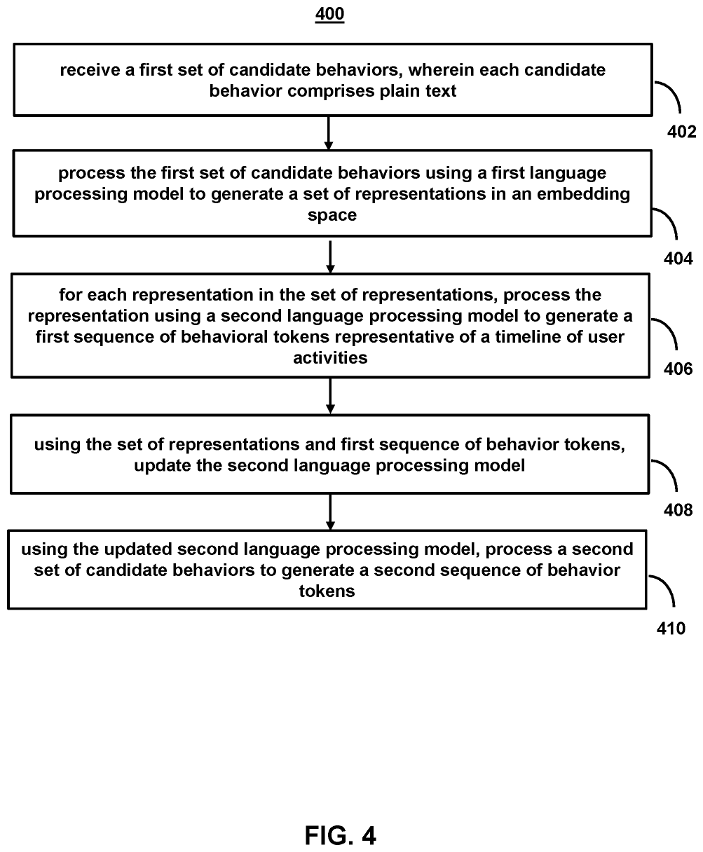

FIG. 4 shows a flowchart of the steps involved in generating synthetic data using a first language processing model for a second model, in accordance with one or more embodiments. For example, the system may use process 400 (e.g., as implemented on one or more system components described above) in order to process plain-text behavior descriptions using a first model to generate representations in a real-valued space, use the representations to create behavior token sequences, and use the behavior token sequences to train or update a second model.

At step 402, process 400 (e.g., using one or more components described above) receives a first set of candidate behaviors, wherein each candidate behavior comprises plain text. The system (e.g., system 100) may receive First Candidate Behaviors 132. First Candidate Behaviors 132 may be plain text descriptions of various hypothetical scenarios. In some embodiments, the hypothetical scenarios may pertain to actions by one or more users and/or responses to actions by users. For example, a candidate behavior in First Candidate Behaviors 132 may be that a user used too much bandwidth on a network, causing a crash. First Candidate Behaviors 132 may contain a plurality of candidate behaviors in a dataset format. Each entry in the dataset may be text describing a candidate behavior, the text comprising sequence(s)s of words, sentences, paragraphs, or passages in any combination. In some embodiments, the system may discretize candidate behaviors in First Candidate Behaviors 132 to consist of text tokens. Each text token may, for example, be a word or a punctuation mark. Alternatively, text tokens may correspond to sentences. Text tokens may contain text in plain alphanumerical form, and may not be embedded to real values. In some embodiments, First Candidate Behaviors 132 may be associated with a set of labels. The labels may indicate an outcome expected from the candidate behaviors described, or a real outcome observed from a real event described using a candidate behavior. The relationship between a candidate behavior and an outcome may be predetermined before First Candidate Behaviors 132 is processed by language models. For example, a candidate behavior may describe a user overloading a network. The candidate behavior may be associated with an expected outcome, which may be determined to be network failure.

At step 404, process 400 (e.g., using one or more components described above) processes the first set of candidate behaviors using a first language processing model to generate a set of representations in an embedding space. The system may process the First Candidate Behaviors 132 using a first language processing model (e.g., First Language Processing Model 112) to generate a set of representations. First Language Processing Model 112 may be, for example, a deep learning model trained to map candidate behaviors to user activity representations in the real-valued embedding space. First Language Processing Model 112 may use algorithms such as word2vec, doc2vec, bidirectional encoder representations, or TF-IDF. First Language Processing Model 112 may take as input text tokens corresponding to a candidate behavior in First Candidate Behaviors 132, for example. First Language Processing Model 112 may output a set of representations in a first real-valued space. Representations may be referred to as embeddings herein. Each representation in the set of representations may be a sequential data structure in the first real-valued space. For example, a representation may include a set of tokens, each of which contains one or more real numbers, and a set of sequential relations indicating a linear order among the set of tokens. For example, a representation may be similar to a linked list, the contents of which are real numbers symbolizing text tokens.

First Language Processing Model 112 may be trained on training data containing candidate behaviors in the same format as First Candidate Behaviors 132. For example, the system may use unsupervised learning to train a deep neural network which translates candidate behaviors into representations in the first real-valued space. For example, First Language Processing Model 112 may be trained on candidate behaviors whose correct embeddings in the first real-valued space are known. Using a supervised or reinforcement learning framework, the system in this example may train First Language Processing Model 112 on a loss metric symbolizing the alignment between the output of First Language Processing Model 112 and the true representation corresponding to a candidate behavior.

In some embodiments, First Candidate Behaviors 132 may be labeled with outcomes. First Language Processing Model 112 may process the labeled candidate behaviors to generate a set of representations labeled with outcomes. The labeled set of representations may be used to train Second Language Processing Model 114.

At step 406, process 400 (e.g., using one or more components described above) processes the representation using a second language processing model to generate a first sequence of behavioral tokens representative of a timeline of user activities for each representation in the set of representations. For each representation in the set of representations, the system may process the representation using a second language processing model (e.g., Second Language Processing Model 114). For each representation of a candidate behavior, Second Language Processing Model 114 may output a sequence(s) of behavior tokens representative of a timeline of user activities (e.g., First Behavior Token Sequence(s) 116). Second Language Processing Model 114 may be trained to perform sequential next-token prediction using a transformer algorithm. Second Language Processing Model 114 may generate First Behavior Token Sequence(s) 116 based on an input representation by processing the sequential data structure of the input representation to determine a first set of candidate tokens. The first candidate tokens represent a set of expected continuations to the input representation, for example, a next action in a sequence(s) of actions. Each candidate token may be associated with a probability, indicating the relative likelihood that the candidate token is the correct continuation of the sequence(s) so far. After generating the first candidate token, Second Language Processing Model 114 may process the input representation in conjunction with a selected first candidate token as a prototype of First Behavior Token Sequence(s) 116 to generate a second set of candidate tokens, each of which are also associated with a probability. The system may select a token from the second set of candidate tokens, and iteratively use Second Language Processing Model 114 to process the current length of First Behavior Token Sequence(s) 116 to generate next tokens. By doing so, Second Language Processing Model 114 is able to consider the full context leading up to any particular token. Second Language Processing Model 114 may be trained on, for example, input representation sequence(s) s in an unsupervised learning framework. In some embodiments, First Candidate Behaviors 132 may be labeled with a set of outcomes. Using representations of First Candidate Behaviors 132 generated by First Language Processing Model 112 in combination with the set of outcomes, the system may train or update Second Language Processing Model 114.

In some embodiments, the system may train Second Language Processing Model 114 by training a first candidate model and a second candidate model. For example, the first candidate model may use an algorithm like a deep neural network. For example, the second candidate model may use a different algorithm like a bidirectional encoder representation algorithm. In some embodiments, the system may use part of the training data for the first candidate model and the remainder of the training data to train the second candidate model. The system may calculate, for example, fit metrics for the first and second candidate models. A fit metric may be a combination of a bias score according to a bias metric and an error score based on cross-validation for a candidate model. Alternatively, the system may calculate performance metrics for the first and second candidate models. A performance metric may indicate, for example, the adherence of a candidate model to a performance standard at runtime. In some embodiments, the system may process a candidate model to extract an attention matrix. The attention matrix may be indicative of extents of consideration the candidate model gives to each of its input features. The system may compare the attention matrix against a preset benchmark attention matrix to generate an attention score. The attention score may, for example, be used as a performance metric. Alternatively or additionally, the attention score may be used to update the candidate model. Using fit metrics and/or performance metrics corresponding to the first and second candidate models, the system may generate Second Language Processing Model 114 by combining parameters from both candidate models as a weighted average using the metrics.

In some embodiments, the system may process Second Language Processing Model 114 to generate a correspondence map, where the correspondence map correlates representations in the embedding space to plain text. The correspondence map may be indicative of the translations between representations and plain text used by Second Language Processing Model 114. The system may use the correspondence map to generate an alignment score for First Language Processing Model 112. For example, the system may compare a representation generated for a particular plain text sequence(s) by First Language Processing Model 112 and a representation generated by the correspondence map. A numerical distance between the two representations in the first real-valued space may be the alignment score. The system may update First Language Processing Model 112 using the alignment score, updating its parameters to achieve an intended threshold of alignment.

At step 408, process 400 (e.g., using one or more components described above) updates the second language processing model using the set of representations and first sequence of behavior tokens. The system may update Second Language Processing Model 114 using the set of representations and First Behavior Token Sequence(s) 116. For example, the system may use a reinforcement learning framework if First Behavior Token Sequence(s) 116 is associated with a set of outcomes. The system may, for example, use a loss function capturing the differences between the output of Second Language Processing Model 114 and the correct outcomes corresponding to a token sequence(s) in First Behavior Token Sequence(s) 116. Parameters for Second Language Processing Model 114 may be updated to minimize the loss function. In some embodiments, the system may use an unsupervised learning approach to update Second Language Processing Model 114 with First Behavior Token Sequence(s) 116.

At step 410, process 400 (e.g., using one or more components described above) processes a second set of candidate behaviors to generate a second sequence of behavior tokens using the updated second language processing model.

Using the updated second language processing model, the system may process a second set of candidate behaviors (e.g., Second Candidate Behaviors 134) to generate a second sequence(s) of behavior tokens (e.g., Second Behavior Token Sequence(s) 118). Second Candidate Behaviors 134 may be in the same format as First Candidate Behaviors 132, and also include text tokens. The system may input Second Candidate Behaviors 134 to First Language Processing Model 112 and generate a second set of representations in the first real-valued space. The system may then input the second set of representations to Second Language Processing Model 114. Second Language Processing Model 114 may generate Second Behavior Token Sequence(s) 118 by iteratively processing the sequential data structures of the input representations to determine sequence(s)s of candidate tokens. Each candidate behavior in Second Candidate Behaviors 134 may correspond to a sequence(s) of candidate tokens, for example.

Second Behavior Token Sequence(s) 118 may be used to train or update other machine learning models. For example, Second Candidate Behaviors 134 and Second Behavior Token Sequence(s) 118 may, in conjunction, be used as training data for a user classification model. Second Behavior Token Sequence(s) 118 may be determined to correspond to a set of severity scores. Users may be associated or correlated with certain behaviors in Second Candidate Behaviors 134, which are in turn associated with severity scores corresponding to Second Behavior Token Sequence(s) 118. In some embodiments, the system may process the first or second sequence(s) of behavioral tokens to determine clusters of user systems using a prototype-based clustering model. Each sequence of behavioral tokens is a prototype used by the prototype-based clustering model. In some embodiments, each cluster of user systems is associated with a scenario description in first set of scenario descriptions.

It is contemplated that the steps or descriptions of FIG. 4 may be used with any other embodiment of this disclosure. In addition, the steps and descriptions described in relation to FIG. 4 may be done in alternative orders or in parallel to further the purposes of this disclosure. For example, each of these steps may be performed in any order, in parallel, or simultaneously to reduce lag or increase the speed of the system or method. Furthermore, it should be noted that any of the components, devices, or equipment discussed in relation to the figures above could be used to perform one or more of the steps in FIG. 4.

The above-described embodiments of the present disclosure are presented for purposes of illustration and not of limitation, and the present disclosure is limited only by the claims which follow. Furthermore, it should be noted that the features and limitations described in any one embodiment may be applied to any embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

The present techniques will be better understood with reference to the following enumerated embodiments:
1. A method comprising: receiving a first set of candidate behaviors, wherein each candidate behavior comprises plain text describing user activity; processing the first set of candidate behaviors using a first language processing model to generate a set of representations associated with the first set of candidate behaviors in a real-valued embedding space, wherein the first language processing model is a deep learning model trained to map candidate behaviors to user activity representations in the real-valued embedding space; for each representation in the set of representations, processing the representation using a second language processing model to generate a first sequence of behavior tokens representative of a timeline of user activities, wherein the second language processing model is trained on prior user activity; and using the set of representations and first sequence of behavior tokens, updating the second language processing model; using the updated second language processing model, processing a second set of candidate behaviors to generate a second sequence of behavior tokens; using the second sequence of behavior tokens, generating notifications indicating expected user activity.
2. A method comprising: receiving a first set of candidate behaviors, wherein each candidate behavior comprises plain text; processing the first set of candidate behaviors using a first language processing model to generate a set of representations in an embedding space; for each representation in the set of representations, processing the representation using a second language processing model to generate a first sequence of behavioral tokens representative of a timeline of user activities; using the set of representations and first sequence of behavior tokens, updating the second language processing model; and using the updated second language processing model, processing a second set of candidate behaviors to generate a second sequence of behavior tokens.
3. The method of any one of the preceding embodiments, further comprising: processing the second language processing model to generate a correspondence map, wherein the correspondence map correlates representations in the embedding space to plain text; using the correspondence map, generating an alignment score for the first language processing model; and based on the alignment score, updating the first language processing model.
4. The method of any one of the preceding embodiments, wherein the second language processing model performs sequential next-token prediction using a transformer algorithm.
5. The method of any one of the preceding embodiments, wherein a representation is a sequential data structure, comprising: a set of tokens comprising real values in the embedding space; and a set of sequential relations indicating a linear order among the set of tokens.
6. The method of any one of the preceding embodiments, further comprising: receiving a set of labelled candidate behaviors; updating the first language processing model based on the set of labelled candidate behaviors to produce a set of labelled representations, wherein the set of labelled representations is associated with a set of outcomes; and using the set of labelled representations and the associated set of outcomes, training the second language processing model to predict outcomes based on input representations.
7. The method of any one of the preceding embodiments, further comprising: training a first candidate model for the second language processing model using a first algorithm; generating a first fit metric associated with the first candidate model, wherein the first fit metric comprises a first bias score and a first error score; training a second candidate model for the second language processing model using a second algorithm; generating a second fit metric associated with the second candidate model, wherein the second fit metric comprises a second bias score and a second error score; and using the first fit metric and the second fit metric, selecting parameters of the second language processing model through a weighted combination of the parameters of the first candidate model and the parameters of the second candidate model.
8. The method of any one of the preceding embodiments, further comprising: training the second language processing model to be a first candidate model using a first algorithm, wherein the first candidate model generates a first output first sequence; using the set of representations and the first output first sequence, generating a first performance metric associated with the first candidate model; training a second candidate model using a second algorithm, wherein the second candidate model generates a second output first sequence; using the set of representations and the second output first sequence, generating a second performance metric associated with the second candidate model; and using the first performance metric and the second performance metric, selecting the second language processing model to be one of the first candidate model and the second candidate model.
9. The method of any one of the preceding embodiments, further comprising: processing the second language processing model to extract an attention matrix, wherein the attention matrix is indicative of extents of consideration the second language processing model gives to each of its input features; comparing the attention matrix against a preset benchmark attention matrix to generate an attention score; and updating the second language processing model based on the attention score.
10. The method of any one of the preceding embodiments, further comprising: obtaining a set of real behaviors associated with the first sequence of behavior tokens generated using the second language processing model; and using the set of real behaviors and the first sequences of behavior tokens, updating the second language processing model.
11. The method of any one of the preceding embodiments, further comprising: using a prototype-based clustering model, processing the first or second sequence of behavioral tokens to determine clusters of user systems, wherein each first sequence of behavioral tokens is a prototype used by the prototype-based clustering model, and wherein each cluster of user systems is associated with a scenario description in first set of scenario descriptions.
12. The method of any one of the preceding embodiments, wherein generating the first sequence(s) of behavioral tokens comprises: based on an input representation, using the second language processing model to generate a first set of candidate tokens, wherein each candidate token in the first set of candidate tokens is associated with a probability; and in response to selecting a candidate token from the first set of candidate tokens, recursively generating sets of candidate tokens based on the input representation and the selected candidate token.
13. One or more non-transitory computer-readable media storing instructions that, when executed by a data processing apparatus, cause the data processing apparatus to perform operations comprising those of any of embodiments 1-12.
14. A system comprising one or more processors; and one or more non-transitory computer-readable media storing instructions that, when executed by the one or more processors, cause the one or more processors to effectuate operations comprising those of any of embodiments 1-12.
15. A system comprising means for performing any of embodiments 1-12.

What is claimed is:

1. A system for generating synthetic training data, the system comprising:
one or more processors; and
one or more non-transitory, computer-readable media storing instructions that, when executed by the one or more processors, cause operations comprising:
receiving a first set of candidate behaviors, wherein each candidate behavior comprises plain text describing user activity;
processing the first set of candidate behaviors using a first language processing model to generate a set of representations associated with the first set of candidate behaviors in a real-valued embedding space, wherein the first language processing model is a deep learning model trained to map candidate behaviors to user activity representations in the real-valued embedding space;
for each representation in the set of representations, processing the representation using a second language processing model to generate a first sequence of behavior tokens representative of a timeline of user activities, wherein the second language processing model is trained on prior user activity; and
using the set of representations and first sequence of behavior tokens, updating the second language processing model;
using the updated second language processing model, processing a second set of candidate behaviors to generate a second sequence of behavior tokens;
using the second sequence of behavior tokens, generating notifications indicating expected user activity.

2. A method for generating synthetic training data, the method comprising:
receiving a first set of candidate behaviors, wherein each candidate behavior comprises plain text;
processing the first set of candidate behaviors using a first language processing model to generate a set of representations in an embedding space;
for each representation in the set of representations, processing the representation using a second language processing model to generate a first sequence of behavioral tokens representative of a timeline of user activities;
using the set of representations and first sequence of behavior tokens, updating the second language processing model; and
using the updated second language processing model, processing a second set of candidate behaviors to generate a second sequence of behavior tokens.

3. The method of claim 2, further comprising:
processing the second language processing model to generate a correspondence map, wherein the correspondence map correlates representations in the embedding space to plain text;
using the correspondence map, generating an alignment score for the first language processing model; and
based on the alignment score, updating the first language processing model.

4. The method of claim 2, wherein the second language processing model performs sequential next-token prediction using a transformer algorithm.

5. The method of claim 2, wherein a representation is a sequential data structure, comprising:
a set of tokens comprising real values in the embedding space; and
a set of sequential relations indicating a linear order among the set of tokens.

6. The method of claim 2, further comprising:
receiving a set of labelled candidate behaviors;
updating the first language processing model based on the set of labelled candidate behaviors to produce a set of labelled representations, wherein the set of labelled representations is associated with a set of outcomes; and
using the set of labelled representations and the associated set of outcomes, training the second language processing model to predict outcomes based on input representations.

7. The method of claim 2, further comprising:
training a first candidate model for the second language processing model using a first algorithm;
generating a first fit metric associated with the first candidate model, wherein the first fit metric comprises a first bias score and a first error score;
training a second candidate model for the second language processing model using a second algorithm;
generating a second fit metric associated with the second candidate model, wherein the second fit metric comprises a second bias score and a second error score; and
using the first fit metric and the second fit metric, selecting parameters of the second language processing model through a weighted combination of the parameters of the first candidate model and the parameters of the second candidate model.

8. The method of claim 2, further comprising:
training the second language processing model to be a first candidate model using a first algorithm, wherein the first candidate model generates a first output first sequence;
using the set of representations and the first output first sequence, generating a first performance metric associated with the first candidate model;
training a second candidate model using a second algorithm, wherein the second candidate model generates a second output first sequence;
using the set of representations and the second output first sequence, generating a second performance metric associated with the second candidate model; and
using the first performance metric and the second performance metric, selecting the second language processing model to be one of the first candidate model and the second candidate model.

9. The method of claim 2, further comprising:
processing the second language processing model to extract an attention matrix, wherein the attention matrix is indicative of extents of consideration the second language processing model gives to each of its input features;
comparing the attention matrix against a preset benchmark attention matrix to generate an attention score; and
updating the second language processing model based on the attention score.

10. The method of claim 2, further comprising:
obtaining a set of real behaviors associated with the first sequence of behavior tokens generated using the second language processing model; and
using the set of real behaviors and the first sequences of behavior tokens, updating the second language processing model.

11. The method of claim 2, further comprising:
using a prototype-based clustering model, processing the first or second sequence of behavioral tokens to determine clusters of user systems, wherein each first sequence of behavioral tokens is a prototype used by the prototype-based clustering model, and wherein each cluster of user systems is associated with a scenario description in first set of scenario descriptions.

12. The method of claim 2, wherein generating the first sequence of behavioral tokens comprises:
based on an input representation, using the second language processing model to generate a first set of candidate tokens, wherein each candidate token in the first set of candidate tokens is associated with a probability; and
in response to selecting a candidate token from the first set of candidate tokens, recursively generating sets of candidate tokens based on the input representation and the selected candidate token.

13. One or more non-transitory computer-readable media comprising instructions that, when executed by one or more processors, cause operations comprising:
receiving a first set of candidate behaviors, wherein each candidate behavior comprises plain text;
processing the first set of candidate behaviors using a first language processing model to generate a set of representations in an embedding space;
for each representation in the set of representations, processing the representation using a second language processing model to generate a first sequence of behavioral tokens representative of a timeline of user activities;
using the set of representations and first sequence of behavior tokens, updating the second language processing model; and
using the updated second language processing model, processing a second set of candidate behaviors to generate a second sequence of behavior tokens.

14. The one or more non-transitory computer-readable media of claim 13, further comprising:
processing the second language processing model to generate a correspondence map, wherein the correspondence map correlates representations in the embedding space to plain text;
using the correspondence map, generating an alignment score for the first language processing model; and
based on the alignment score, updating the first language processing model.

15. The one or more non-transitory computer-readable media of claim 13, wherein the second language processing model performs sequential next-token prediction using a transformer algorithm.

16. The one or more non-transitory computer-readable media of claim 13, wherein a representation is a sequential data structure, comprising:
a set of tokens comprising real values in the embedding space; and
a set of sequential relations indicating a linear order among the set of tokens.

17. The one or more non-transitory computer-readable media of claim 13, further comprising:
receiving a set of labelled scenario descriptions;
updating the first language processing model based on the set of labelled scenario descriptions to produce a set of labelled representations, wherein the set of labelled representations is associated with a set of outcomes; and
using the set of labelled representations and the associated set of outcomes, training the second language processing model to predict outcomes based on input representations.

18. The one or more non-transitory computer-readable media of claim 13, further comprising:
training a first candidate model for the second language processing model using a first algorithm;
generating a first fit metric associated with the first candidate model, wherein the first fit metric comprises a first bias score and a first error score;
training a second candidate model for the second language processing model using a second algorithm;
generating a second fit metric associated with the second candidate model, wherein the second fit metric comprises a second bias score and a second error score; and
using the first fit metric and the second fit metric, selecting parameters of the second language processing model through a weighted combination of the parameters of the first candidate model and the parameters of the second candidate model.

19. The one or more non-transitory computer-readable media of claim 13, further comprising:
processing the second language processing model to extract an attention matrix, wherein the attention matrix is indicative of extents of consideration the second language processing model gives to each of its input features;
comparing the attention matrix against a preset benchmark attention matrix to generate an attention score; and
updating the second language processing model based on the attention score.

20. The one or more non-transitory computer-readable media of claim 13, further comprising:
using a prototype-based clustering model, processing first sequence(s)s of scenario representations to determine clusters of user systems, wherein each first sequence(s) of scenario representations is a prototype used by the prototype-based clustering model, and wherein each cluster of user systems is associated with a scenario description in first set of scenario descriptions.
